(19) United States
(12) Patent Application Publication
(10) Pub. No.: US 2012/0004895 A1
(43) Pub. Date: Jan. 5, 2012

(54) METHOD AND APPARATUS FOR TESTING ON-LINE SERVICES

(75) Inventor: Di Andy Zhang, (US)

(73) Assignee: Nokia Corporation, Espoo (FI)

(21) Appl. No.: 12/981,654

(22) Filed: Dec. 30, 2010

(30) Foreign Application Priority Data
Dec. 31, 2009 (CN) PCT/CN2009/076356

(51) Int. Cl. G06F 17/50

(52) U.S. Cl. 703/13

(57) ABSTRACT

There is disclosed a method, an apparatus, and a computer program for testing on-line services. In an example embodiment a topology (100) describing message channels among entities (110) is selected; and also entities for the selected topology is selected. The entities comprise at least one message interface. A dataflow graph (330) is defined on the basis of the selected entities and the topology. The dataflow graph (330) represents message connections between message interfaces.

### RELATED APPLICATION

This application claims priority to Patent Cooperation Treaty Application No. PCT/CN2009/076356 filed Dec. 31, 2009, which is incorporated herein by reference in its entirety.

### TECHNICAL FIELD

The invention relates to methods and apparatuses for building a testing system to simulate large number of terminals sending correlated data streams to wireless services, and to implement the testing on on-line services.

### BACKGROUND INFORMATION

The rise of novel context-aware services offers great opportunities for mobile industry. Meanwhile, it issues a new challenge to the computing ability of processing vast amounts of data streams rapidly and efficiently.

One aspect of developing context-aware services is how to test, compile statistics on and characterize them in mobile environment, which usually consists of massive, minute, scattered, dissimilar, and mutable terminals.

The correlation, either temporal or contextual, among terminals may be valuable for wireless services, for many of them (social network service SNS, etc.) may rely on mining those correlations to provide users more intelligent services. A tool, named ‘dataflow graph’, can naturally represent the terminals and the interdependence among them. It defines the terminals as a network of entities, which exchange data across predefined connections by message passing.

However, the definition and modification of dataflow graphs are difficult when the graphs are used to simulate complex scenarios. Sometimes, different parts of one graph have completely different structures; or, the structure of graphs needs to vary in running time. The dataflow graph is a model which can be extracted from an algorithmic behavioral description of a scenario. It defines a system as a network of entities, which exchange data across predefined connections by message passing. These entities can be reconnected endlessly to form different applications without having to be changed internally.

As a graph-based model, many concepts and operations in graph theory can be applied to it. Two concepts which can be used in connection with graph-based models are ‘entity’ and ‘topology’. The entity, which can also be named as a node, is an object that has an internal status and can communicate with outside world, e.g. with other entities, by messages, and topology refers to message channels built among entities. The entity may have one or more input ports to receive messages and/or one or more output ports to output messages.

Reusability is one characteristic of modern software systems. Although flexible and intuitive, the dataflow graph may not be easily reused because it may have a flat and irregular structure, in which a slight modification performed on a local part may largely change the behavior of the global model. When the definition of a target scenario varies for some reason, the modeler may sometimes need to rebuild the graph as a whole.

One way to improve the reusability is to partition a large graph to several small sub-graphs, each of which acts as a single node in the large graph. However, the cost of reusing graph may still be quite high, or even ineffective in practice.

### SUMMARY

In some example embodiments of the present invention a dataflow graph is treated as an integration of a topology and a set of entities. The dataflow graph can be produced by the fabrication of predefined topology and entities.

To explain the idea more clearly, let us get down to the fundamental of modeling and see how models are defined. Usually, the phrase of “using dataflow graphs” makes people come out of an image that a designer defines his model by drawing connections between nodes right before his desk. Sometimes, it is true for simple graphs; more commonly, however, it may be impossible to visually edit a large-scale graph that consists of millions of nodes, or a graph inter-linked by edges constructed randomly, or mutable during runtime. Thus, a dataflow graph on a computer is essentially a piece of computer code, and a topology and an entity mentioned here may also be computer programs. Integrating a topology and an entity to a graph can be considered as generating one piece of code by combining two other pieces of code automatically.

In some example embodiments the modeler may create or specify a topology and entities to be associated at first, and submit them to an apparatus, which generates the dataflow graph and runs it for the modeler automatically. One central feature of the approach is the reusability. When the existing scenario needs to be altered, the approach can simulate new scenarios by reconfiguring the existing components with less effort than defining the model from scratch again. With a well managed repository where useful topologies and entities accumulate, the modeler may achieve a continuously increasing productivity as well as better system maintainability.

According to a first aspect of the present invention there is provided a method comprising:

selecting a topology describing message channels among entities;

selecting entities for the selected topology; said entities comprising at least one message interface;

defining a dataflow graph on the basis of the selected entities and the topology; said dataflow graph representing message connections between message interfaces.

According to a second aspect of the present invention there is provided an apparatus comprising:

means for selecting a topology describing message channels among entities;

means for selecting entities for the selected topology; said entities comprising at least one message interface;

means for defining a dataflow graph on the basis of the selected entities and the topology; said dataflow graph representing message connections between message interfaces.

According to a third aspect of the present invention there is provided a computer program product stored on a storage medium comprising a computer program code configured to, with at least one processor, cause an apparatus to:

select a topology describing message channels among entities;

select entities for the selected topology; said entities comprising at least one message interface;

define a dataflow graph on the basis of the selected entities and the topology; said dataflow graph representing message connections between message interfaces.

According to a fourth aspect of the present invention there is provided an apparatus comprising:

a selector configured to select a topology describing message channels among entities, and to select entities for the selected topology; said entities comprising at least one message interface;

a definer configured to define a dataflow graph on the basis of the selected entities and the topology; said dataflow graph representing message connections between message interfaces.

### DESCRIPTION OF THE DRAWINGS

In the following some example embodiments of the present invention will be described in more detail with reference to the appended drawings, in which

FIG. 1a depicts an example topology of a linear road and some entities used with the linear road topology;

FIG. 1b depicts an example topology of a circular road and some entities used with the circular road topology;

FIG. 1c depicts an example topology of a linear road and some examples of different kind of entities used with the linear road topology;

FIGS. 2a-2d depict examples of topologies and entities in an environment relating to an on-line service that enables people to send instant messages to each other;

FIG. 3 depicts an example of the relationship between an entity, a topology and a graph;

FIG. 4 depicts an example of the control of a running graph as a block diagram;

FIG. 5 depicts an example of a system in which the invention can be implemented;

FIG. 6 depicts a software system of an apparatus according to an example embodiment of the present invention as a block diagram;

FIG. 7 depicts an apparatus according to an example embodiment of the present invention as a block diagram;

FIGS. 8a and 8b depict a method according to an example embodiment of the present invention as a flow diagram;

FIG. 9 depicts an example of an entity as a simplified block diagram; and

FIG. 10 depicts three examples of testing an on-line service

### DETAILED DESCRIPTION OF SOME EXAMPLE EMBODIMENTS

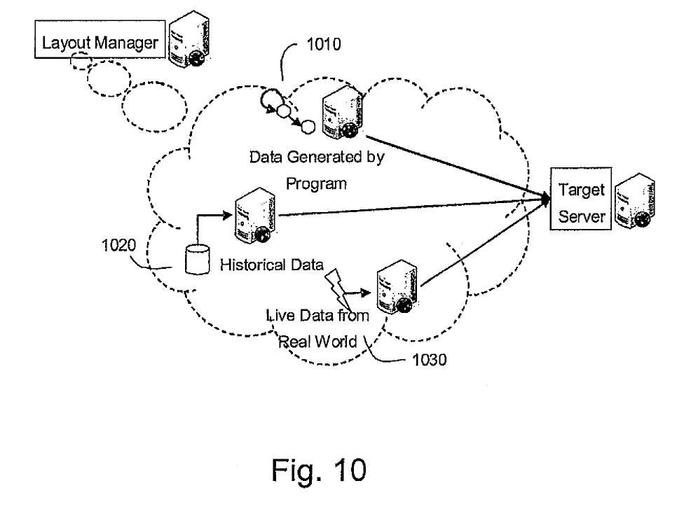

FIG. 10 depicts an example scenario of testing an on-line service. In order to test the service's functionality or performance, the user-defined data are sent to the service via a certain protocol and port. There can be, for example, the following three ways to generate testing data. First, writing a computer program to simulate the required data, probably based on certain kinds of formal models. This is depicted with the reference numeral 1010 in FIG. 10. Another way is to replay historical data, which is depicted with the reference numeral 1020 in FIG. 10. The third alternative is to collect live data from real world. This is depicted with the reference numeral 1030 in FIG. 10. The above mentioned three methods may also be used in a hybrid way. In the present invention the first method 1010 has been taken as the foundation of the testing system.

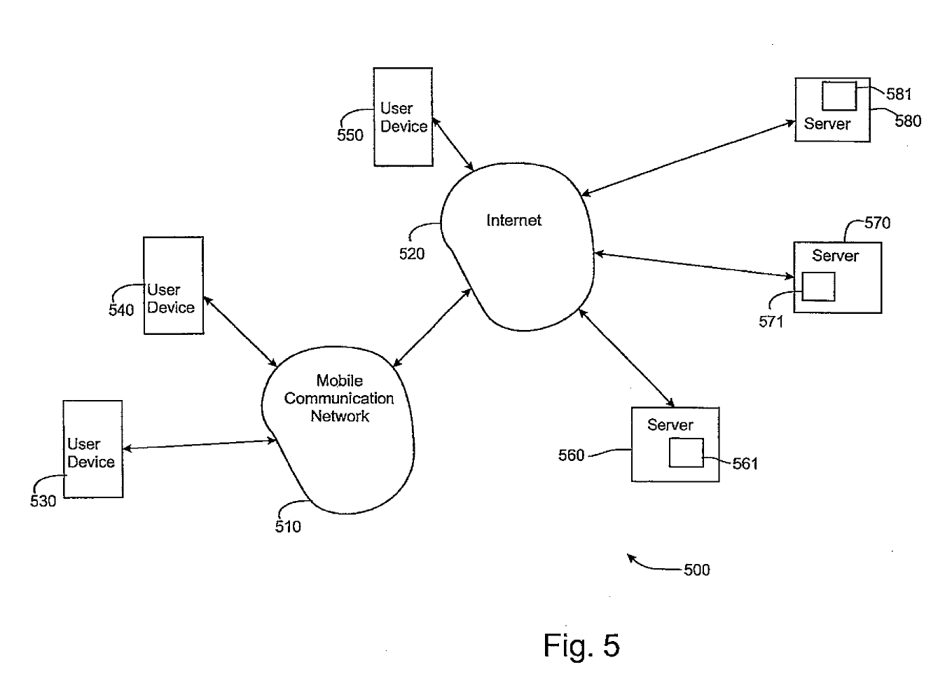

In the following a simplified example embodiment of a system is disclosed in which the present invention can be implemented. The system is depicted in FIG. 5. In this example embodiment the system 500 comprises user devices 530, 540, 550 which users can use to, for example, browse web pages, send and receive emails, exchange images, messages etc. with other users in the network, handle calendar events, make phone calls, run other applications, etc. The user devices 530, 540, 550 may be able to communicate with one or more communication networks 510, 520, such as a mobile communication network 510, a local area network (LAN), a wireless local area network (WLAN), an internet 520, etc. The system 500 also comprises network servers 560, 570, 580 which may contain (networked) items 561, 571, 582, such as web pages, images and/or documents, so that users can, for example, browse web pages, download images, documents, maps, application software etc. to the user devices. Also the user devices 530, 540, 550 may contain items which are stored locally by the user device 530, 540, 550. However, the invention can also be implemented within one device without a connection to other devices. The invention can also be implemented as a network service, for example in one or more network servers 560, 570, 580.

The user devices 530, 540, 550 may be computer apparatuses such as laptop and/or desktop computers, wireless terminals such as mobile communication devices, etc.

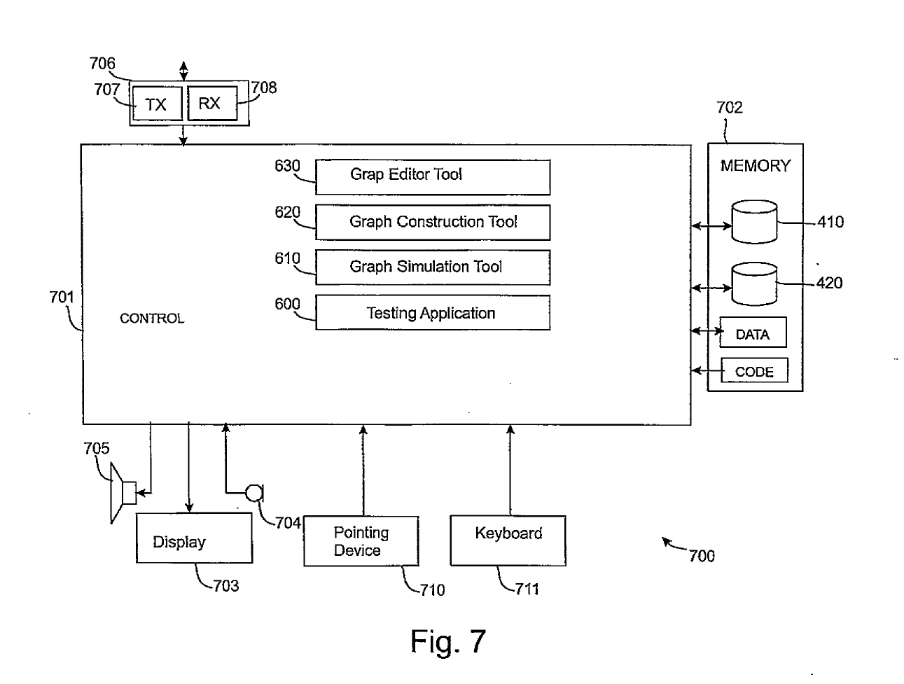

FIG. 7 depicts an apparatus 700 according to an example embodiment of the present invention as a block diagram. The apparatus can be used e.g. as the user device 530, 540, 550 in the system 500. The apparatus 700 comprises a control block 701 which may contain a processor or other means to control the operation of the apparatus 700 and to run programs (applications). The apparatus 700 also comprises a memory 702 for storing data and program code. The apparatus 700 further comprises at least one display 703 for displaying data, and may also comprise a microphone 704 and a loudspeaker 705. The apparatus 700 can communicate with the network by using the communication means 706 which may comprise a transmitter 707 for transmitting information to the communication network and a receiver 708 for receiving information from the communication network.

In FIG. 7 some of the processes relating to the present invention are depicted as blocks inside the control block 701. In practical implementations these processes may be implemented as a program code which can be executed by at least one processor, for example, to perform the tasks of the processes. Therefore, the at least one processor, when running program code stored into at least one memory, can cause the apparatus 700 to perform e.g. the selection of topology and entities, graph construction, and running the graph.

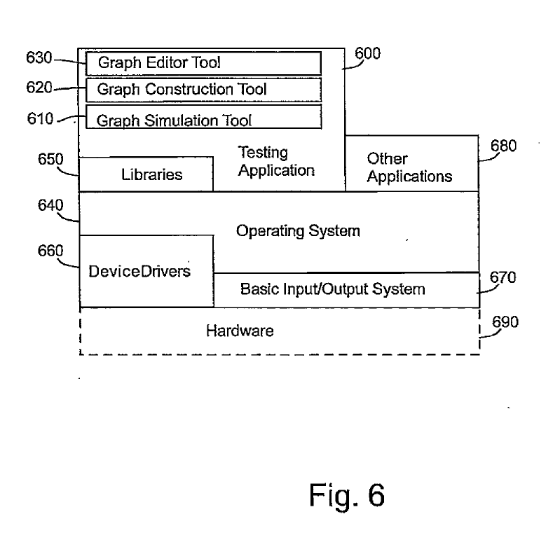

FIG. 6 depicts a software system of the apparatus 700 according to an example embodiment of the present invention as a simplified block diagram. The software system may comprise an operating system 640, a basic input/output system 670 (BIOS), device drivers 660, libraries 650, the testing application 600 according to an example embodiment of the present invention, and other applications 680. The operating system may control the execution of the applications 600, 680 and may also have interface to the device drivers 660 and to the BIOS 670 to have the hardware 690 of the apparatus 700 operate appropriately. For example, signals from the keyboard 711 regarding keystrokes may be detected by a device driver and proceeded to the operating system which determines which application should receive the signals. Also information to be displayed on the display 703 may come from an application 600, 680 to the operating system which delivers the information to a device driver which is designed for controlling the display hardware.

In the following the invention will be illustrated with some examples of topologies and entities are illustrated.

A typical scenario to be simulated is a single lane road on which a queue of cars are running. With the constraint of no passing-by, one car needs the position of its preceding car before it could calculate its own position in every cycle of the graph running. Thus, the location data generated by the cars consistently flows from the head of the queue to the rear of the queue. Using a method according to an example embodiment of the present invention, the modeler can define two kinds of entities that are the leader car and the follower car, and one topology, mounting a leader with a string of followers.

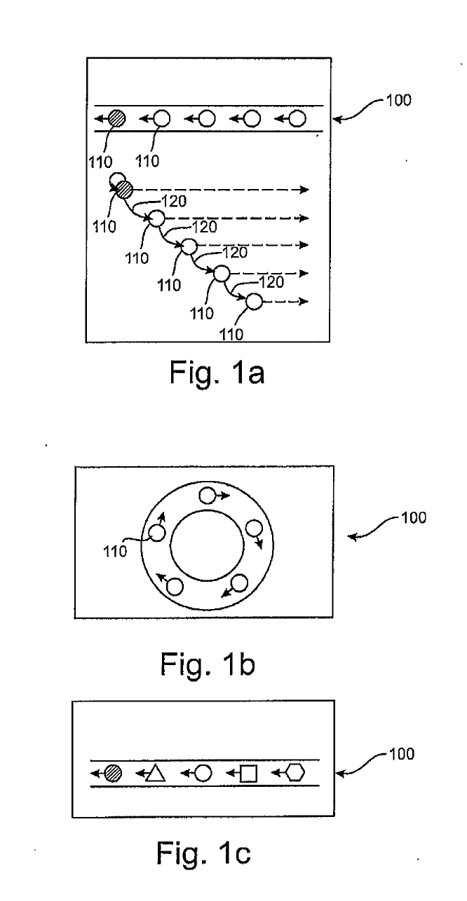

In the example of FIG. 1a a linear road is used as a topology 100. The linear road can be filled with entities 110 which in this example are cars. The shadowed circle denotes the leader car, while the blank circles denote follower cars. The arrows illustrate the direction the cars are driving along the road. The graph is built so that the leader car is positioned at some point of the road, one follower car is added behind the leader car, another follower car is added after the first follower car etc. The building process, which builds the graph when the topology and the entities are selected and located to their positions (i.e. the road model and the cars in this example), mark appropriate links from one entity (leader car, follower car) to the next entity. These links are illustrated with the arrows 120 from one entity to another entity in FIG. 1a. The building process may also make a graph as is illustrated in FIG. 1a.

FIGS. 1b and 1c depict how an example embodiment of a method according to the present invention responds to changes in the scenario. FIG. 1b gives the situation in which the road changes to a loop, and FIG. 1c gives the situation in which different entities, including a bus or buses, people, etc, are mixed with cars already in the road. The former changes the linear topology to a loop but reuses the same entities, while the latter adds new entities onto the linear road without any change to its topology. Different kind of entities (e.g. buses, cars, people) are depicted with different kind of symbols in FIG. 1c.

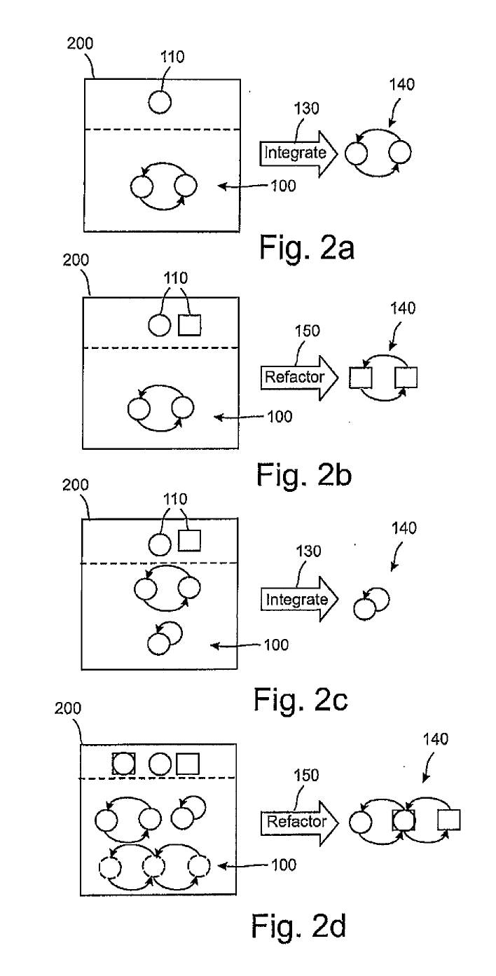

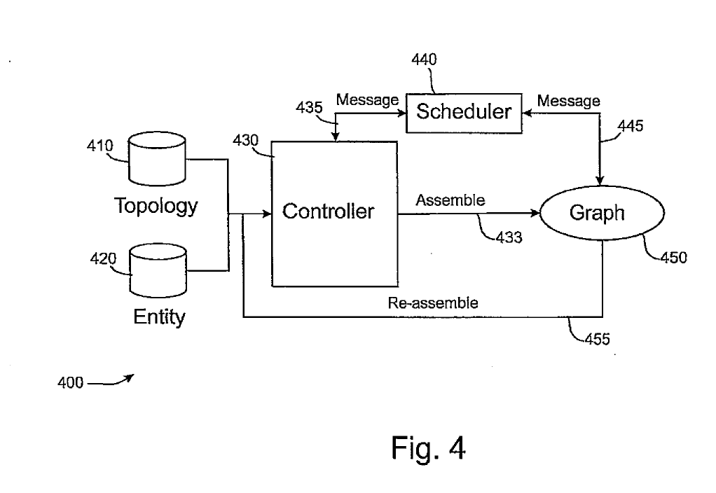

Another example concerns an on-line service that enables people to send instant messages to each other. One day, the service is upgraded to provide extra functionality to pairs of specific users chatting frequently. To test such kind of a service, a dataflow graph 140 is defined as depicted in FIG. 2a, denoting two friends talking to each other alternately. The topology 100 is taken from a topology database 410 (FIG. 4) and the entities are taken from an entity database 420. The selected entities are integrated 130 into the selected topology to build the appropriate graph 140. Later, the service further extends its new functionality from English speakers to Chinese speakers. By reusing 150 the original topology 100, a new entity can be defined to meet such requirement change easily, shown in FIG. 2b. The new entity representing a Chinese speaker is illustrated as a square whereas the entity representing an English speaker is illustrated with a circle. At some moment the service may want to find out other types of people involved in, such as a “self-talker” who just thinks aloud (FIG. 2c) or an interpreter for other users (FIG. 2d), and their dataflow graphs can be easily defined without much effort as well.

In FIGS. 2a-2d the available topologies in the topology database 410 are illustrated with different symbols on the lower part of the square 200 on the left hand side of the Figures and the available entities in the entity database 420 are illustrated with different symbols on the upper part of the square 200 on the left hand side of the FIGS. 2a-2d.

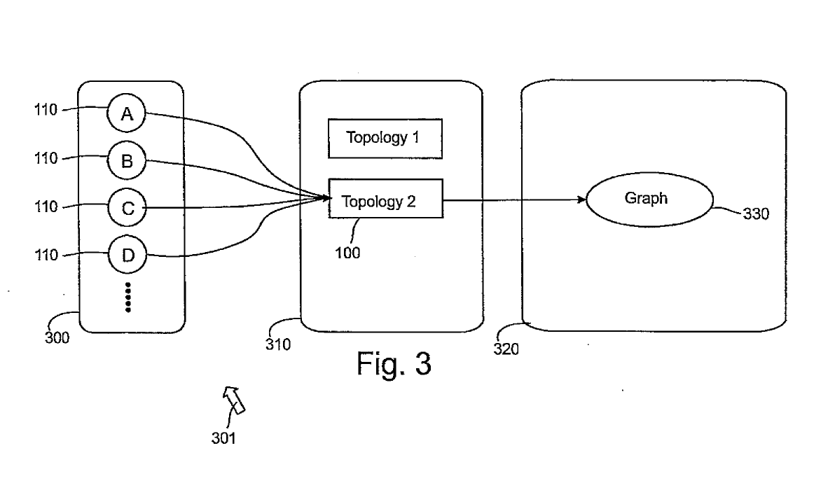

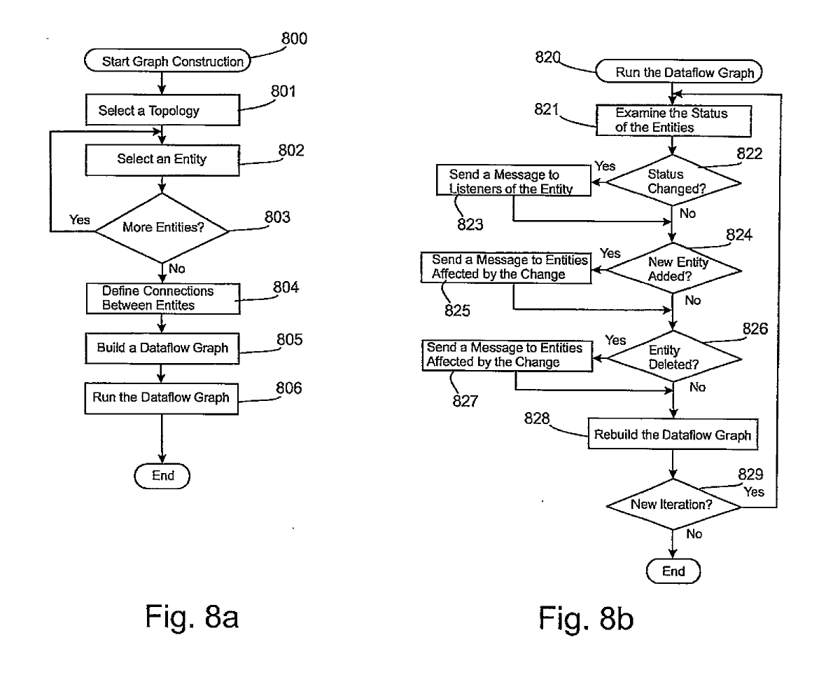

Dataflow graphs can be generated by connecting entities according to the definition of a topology. An example method of the dataflow graph construction and running is depicted in FIGS. 8a and 8b as flow diagrams 800 and 820. An example of the relationship between an entity, a topology and a graph is illustrated in FIG. 3. The apparatus 700 may present a window 300 on the display 703 of the apparatus in which available entities 110 or part of them are shown as a first set of graphical symbols in the window 300. The apparatus 700 may also present available topologies 100 or part of them in the same window 300 or in another window 310 as a second set of graphical symbols. The user of the apparatus 700 can select one or more entities 110 and the topology 100 to be used (depicted as blocks 801 and 802 in FIG. 8a). The user can also define connections between the entities 110. For example, in the situation of FIG. 2d the user selects the interpreter (illustrated with a symbol consisting of a circle in a square) and the English speaker (illustrated with a circle) and the Chinese speaker (illustrated with a square). The user also selects the topology which comprises three entities one of which contains the bilingual entity. For example, the user may use a pointing device 710 of the apparatus to point the correct topology in the window 310 and drags and drops the symbol representing the selected topology into the graph window 320. The user also can use the pointing device 710 drag and drop the symbol representing the selected entities into the graph window 320. The symbol representing the English speaker is dropped onto the circle of the topology symbol in the graph window 320 and, respectively, the symbol representing the Chinese speaker is dropped onto the square of the topology symbol in the graph window 320. Then, when no more entities are to be entered (block 803), the build process, e.g. the graph construction tool 620 illustrated in FIGS. 6 and 7, builds the graph. It may be built, for example, by constructing a piece of code in which the entities and the topologies are included and some parameters and connections between entities are modified appropriately (blocks 804 and 805).

The graph construction tool 620 may also compile a program code to be stored into the memory 702 of the device 700 so that the processor of the device 700 can execute the program code to simulate the operation of the graph. The graph simulation tool 610 illustrates the means for simulating the data flow graph built by the graph construction tool 620. The graph simulation tool 610 may reserve some areas from the memory 702 for storing the structure of the data flow graph, parameters, messages and other information needed during the execution of the data flow graph, etc.

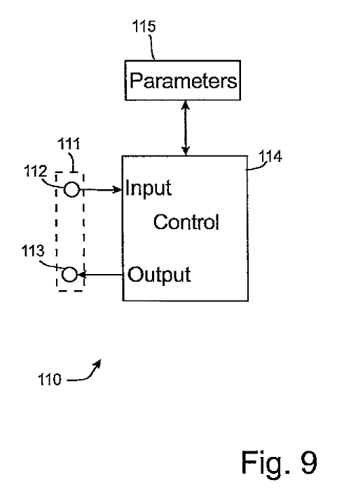

The entity 110, in the data flow graph, can be implemented as an object storing a group of entities listening to it. An example of a logical structure of an entity 110 is depicted in FIG. 9. The entity 110 comprises a message interface 111 via which the entity can exchange messages with e.g. other entities. For example, the entity can receive messages through the input port 112 of the message interface and/or transmit messages through the output port 113 of the message interface. The entity 110 may also comprise a control block 114 which performs operations assigned to the entity. The operations may be different with different kind of entities. The entity 110 may further comprise parameters 115 to control the operation of the entity. The entity 110 can be implemented as a program code, for example as a class, wherein the input port 112 and the output port 113 can be input and output parameters of the class and the control block 114 contains computer code for performing the desired operation. The parameters 115 can be internal or external variables, constants, etc.

An example of running the graph is depicted in FIG. 8b. The status of the entity is examined (blocks 821 and 822). When an entity changes its content, it broadcasts the listeners a message (block 823), which may contain e.g. the origin, time, and content of the change. The message may be transmitted via a message interface of the entity. The message interface may comprise an input port for receiving a message, an output port for sending a message, or both. Then, the listeners start to update their content based on the message, and then broadcast new messages to their own followers. Running of the graph is driven by the messages propagated around the graph. In order to implement the above process, the entity, as the form of a class, contains a data structure (a listener set) to store information on the listeners of the entity. The operations imposed on the listener set will not affect other data, such as content, inside the entity class.

The user may also add an entity (block 824), wherein a message may be transmitted e.g. from the new entity to entities which are affected by the change (block 825). For example, if an entity is added between two interconnected entities, the message is transmitted to both the interconnected entities so that they can reconfigure the information regarding connections to other entities.

The user may also delete an entity from the dataflow graph (block 826), wherein a message may be transmitted e.g. from the new entity to entities which are affected by the change (block 827). For example, if an entity between two interconnected entities is deleted, the message is transmitted to both the interconnected entities so that they can reconfigure the information regarding connections to other entities.

The dataflow graph may be rebuilt (block 828) during each iteration of the dataflow graph. It is also possible that the dataflow graph is iterated several times. A check can be made (block 829) to determine whether the dataflow graph is to be iterated again or not.

The connections among entities are built by the topology, which implements an interface which takes a certain number of separated entities as an input, and outputs the generated graph as a whole. The connecting actions made by topology are actually merely adding items to the listener set inside each entity, and therefore, theoretically, the feasibility of decoupling approach here is possible due to the fact that any entity can be embedded to any position of any topology, because one entity can be attached to an arbitrary number of heterogeneous listeners if needed.

The case in FIGS. 1a-1c can be implemented as the following code, for example. The entities for the leader car (LeaderCar) and the follower car (FollowerCar) can be defined e.g. as described below:

```
class LeaderCar : public Entity
{
public:
//Leader's update function
virtual void updateEntityStatus(const Entity_Attribute * parent_attribute){
//parent_attribute is actually the status value (position etc.) of itself in last
step
  compute_leader_next_position(parent_attribute);
advance_step( );
}
};
REGISTER_ENTITY_TYPE(LinearRoadLeader);
class FollowerCar : public Entity
{
public:
//Follower's update function
virtual void updateEntityStatus(const Entity_Attribute * parent_attribute){
//parent_attribute is the status value (position etc.) of its parent in this step
compute_follower_next_position(parent_attribute);
  advance_step( );
}
};
```

In the linear road scenario described above, the topology LinearRoadTopology can be defined as below:

```
class LinearRoadTopology( ) : public Topology
{
public:
//Setup dataflow graph
virtual void setupGraph(Entity[ ] entity_set) {
Entity* leader=entity_set[1];
//1 is the unique id of the leader in LinearRoadTopology
leader.link_child(leader);//the leader links to itself
  //each of other entities links to its parent
  for(int i = 1; i< N ; ++i)
entity_set[i].link_child(entity_set[i+1]);
  }
};
REGISTER_TOPOLOGY(LinearRoadTopology);
```

Then, the simulation can be run as below:

```
  //the total number of entities is N
  var leader_num = 1;
  var follower_num = N −1;
  var simulation_step_num = 100;
  var entity_set;
  LinearRoadTopology linear_road_topology;
  entity_set=create_entity(“LeaderCar”, leader_num)+create_entity
(“FollowerCar”, follower_num);
  SET_SIMULATION_DURATION(simulation_step_num);//set the
duration of the simulation
  GENERATE_AND_RUN(entity_set, linear_road_topology);
```

In a running graph, either its entities or topology can be dynamically added, removed, or modified. One example of the controlling scheme of graphs is shown in FIG. 4.

The controller 430 assembles graphs and runs them with a scheduler 440, where the messages generated from running graphs are buffered, or even reordered according to a predefined strategy. One featured characteristic of the system is that graphs can be reassembled in running time. The topology, from the view of the implementation, means all the elements in listener sets inside entities and can be cancelled not by destroying the entire entities but only affecting the data structure storing listeners. For every single entity, reforming topology merely means emptying its existing elements in the listener set, and filling it with new elements given by the logic of the new topology.

Like topology, evolved entities can also enter or leave the graph at any time. With running control, simulations of time-variable scenarios becomes much easier by switching component in graphs at the time the user prefers, avoiding to synthesize completely different topologies or entities in a very unnatural way.

For example, if the user wanted to switch the road from linear shape to a loop one, he only needs to define a new topology for the loop road as below and reuse the definition for the class FollowerCar described above.

```
class LoopRoadTopology( ) : public Topology
{
public:
//Setup dataflow graph
virtual void setupGraph(Entity[ ] entity_set) {
  //every entity links to its parent
  for(int i = 1; i< N ; ++i)
entity_set[i].link_child(entity_set[i+1]);
  entity_set[N].link_child(entity_set[1]);
}
REGISTER_TOPOLOGY(LoopRoadTopology);
```

The way to run the simulation is similar to the linear road scenario:

```
  //the total number of entities is N
  var follower_num = N;
  var simulation_step_num = 100;
  var entity_set;
  LoopRoadTopology loop_road_topology;
  entity_set = create_entity(“FollowerCar”, follower_num);
  SET_SIMULATION_DURATION(simulation_step_num);//set the
duration of the simulation
  GENERATE_AND_RUN(entity_set, loop_road_topology);
  SET_SIMULATION_DURATION(simulation_step_num);
  SWITCH(entity_set, loop_road_topology);
```

In this case, the definition for class LinearRoadTopology described above can be reused and dynamically add different follower types, e.g. FollowerTrunk etc., onto the existing road.

Some functionalities can be provided to facilitate the interaction process with modelers. The running graph can be visualized to the user e.g. on the display 703, which helps the user validate the models with his expected scenarios. Also a repository can be provided containing some most frequently used components, or some samples for the users to show them how to define new components for their own.

In a situation in which a user wants to change the configuration of the system to be tested it may be performed during the execution of the testing or halting the execution to make changes to the configuration. Changes can be performed e.g. by using the user interface of the apparatus 700. The user may select an entity from the window 300 (FIG. 3) by e.g. moving the cursor 301 by the pointing device on the desired entity and selecting the entity by pressing a key of the pointing device or by using another way to indicate to the apparatus 700 that the entity under the cursor 301 is to be selected. Then, the selected entity, or actually the graphical representation of the entity on the display, can be moved by using the pointing device to the location the user wants the entity to be inserted. For example, in the embodiment of FIG. 1a the user may want to add an entity corresponding to a bus between the leader car and the first follower car. Then, the user could select from the entities displayed in the window 300 that entity which is used to represent buses, and move the entity between the leader car and the first follower car in the graph window 320 (FIG. 3). The graph editor tool 630 recognizes that a new entity is positioned between two entities and informs the graph construction to 620 to make changes to the graph. The graph construction tool 620 changes in the leader car entity the information which indicates the follower car entity to correspond with the new entity. Respectively, in the new entity, information referring to the follower car is added to the data structure. The graph construction tool 620 can also update the graph on the display so that the changes in the graph are visible on the display.

In a situation in which a user wants to remove some entity or entities the procedure can be quite similar than described above. The user can move the cursor on the entity he wants to be removed and, for example, selects from a menu the option which is used to remove an entity (e.g. an option named as “Remove” or “Delete”). Then, the graph editor tool 630 informs the graph construction tool 620 about the changes in the graph so that the graph construction tool 620 can make corresponding changes to the data structure of the graph and updates the graph on the display.

It should be noticed that there are many ways to implement the above described procedures. The graph editor tool 630, the graph construction tool 620 and the graph simulation tool 610 need not be separate programs but they can also be implemented within one program module, for example.

Other possible benefits of the present invention may include, but not limit to, the following. It can support an incremental process of modeling, where the modeler works out an accurate model by refining his model iteratively; the separation of the topology and entity may help the modeler analyze the target scenario with a clearer vision than before; the topology and entities can be dynamically replaced in runtime to simulate some time-variable scenarios; the ‘topology’ is actually a high order topology whose number of entities are variable, as it has shown in the road case where the road topology needs not be changed for different number of cars, therefore the flexibility of topology implemented here may be higher than many others confined to some specific description languages; and this approach could be used to enforce other graph-based models as well, such as finite-state machine, Petri net and so on.

The method according to an example embodiment of the present invention can be utilized in various fields spanning broadly, such as wireless service testing, social network simulation, user experience study, game engine, etc.

The implementation of the present invention is not confined to specific platform or programming paradigms, such as object-oriented, functional languages, etc. Here a referential object-oriented implementation for the method was given.

The invention may also improve the productivity and maintainability of a computer simulation based on dataflow graphs.

What is claimed is:

1. A method comprising:
selecting a topology describing message channels among entities;
selecting entities for the selected topology; said entities comprising at least one message interface;
defining a dataflow graph on the basis of the selected entities and the topology; said dataflow graph representing message connections between message interfaces; and
running the dataflow graph to simulate the operation of the topology and the selected entities.

2. The method according to claim 1 further comprising:
presenting on a display a first set of graphical symbols representing selectable entities;
presenting on a display a second set of graphical symbols representing selectable topologies; and
presenting the selected dataflow graph on the display using the graphical symbol representing the selected entities and the graphical symbol representing the selected topology.

3. The method according to claim 1 further comprising monitoring the status of said selected entities; and if a change in the status of at least one entity is detected, sending a message from the at least one entity to inform the change in the status using the dataflow graph to determine a receiver of said message.

4. The method according claim 1 further comprising selecting a first entity and a second entity among the selected entities; and connecting the first entity with the second entity for delivering messages between the first entity and the second entity.

5. The method according to claim 5, said message interface comprising an input port and an output port, wherein the method further comprises connecting the output port of the first entity to the input port of the second entity for delivering messages from the first entity to the second entity.

6. The method according to claim 1 further comprising:
selecting another topology for the dataflow graph; and
reconfiguring the dataflow graph by using the selected another topology and the selected entities.

7. An apparatus comprising
at least one processor
and at least one memory including computer program code the at least one memory and the computer program code configured to, working with the at least one processor, cause the apparatus to perform at least the following:
select a topology describing message channels among entities;
select entities for the selected topology; said entities comprising at least one message interface;
define a dataflow graph on the basis of the selected entities and the topology; said dataflow graph representing message connections between message interfaces; and
run the dataflow graph to simulate the operation of the topology and the selected entities.

8. The apparatus according to claim 7 further comprising
at least one processor
and at least one memory including computer program code
the at least one memory and the computer program code configured to, working with the at least one processor, cause the apparatus to perform at least the following:
present on a display a first set of graphical symbols representing selectable entities; and
present on a display a second set of graphical symbols representing selectable topologies.
present the selected dataflow graph on the display using the graphical symbol representing the selected entities and the graphical symbol representing the selected topology.

9. The apparatus according claim 7 further configured to monitor the status of said selected entities; and if a change in the status of at least one entity is detected, sending a message from said at least one entity to inform the change in the status using the dataflow graph to determine a receiver of said message.

10. The apparatus according claim 7 further caused to perform the following:
select a first entity and a second entity among the selected entities; and
connect the first entity with the second entity for delivering messages between the first entity and the second entity.

11. The apparatus according to claim 10, said message interface comprising an input port and an output port, wherein the apparatus is further caused to perform the following:
connect the output port of the first entity to the input port of the second entity for delivering messages from the first entity to the second entity.

12. The apparatus according to claim 7, wherein the apparatus is further caused to perform the following:
select another topology for the dataflow graph; and
said apparatus is further caused to perform the following:
reconfigure the dataflow graph by using the selected another topology and the selected entities.

13. A computer program product stored on a storage medium comprising a computer program code configured to, with at least one processor, cause an apparatus to:
select a topology describing message channels among entities;
select entities for the selected topology; said entities comprising at least one message interface;
define a dataflow graph on the basis of the selected entities and the topology; said dataflow graph representing message connections between message interfaces; and
run the dataflow graph to simulate the operation of the topology and the selected entities.

14. An apparatus comprising:
a selector configured to select a topology describing message channels among entities, and to select entities for the selected topology; said entities comprising at least one message interface;
a definer configured to define a dataflow graph on the basis of the selected entities and the topology; said dataflow graph representing message connections between message interfaces;
at least one processor; and
at least one memory, said at least one memory comprising computer code when executed by the processor causes the apparatus to configured to run the dataflow graph to simulate the operation of the topology and the selected entities.

15. The apparatus according to claim 14 further comprising a display configured to:
present a first set of graphical symbols representing selectable entities; and
present a second set of graphical symbols representing selectable topologies.
present the selected dataflow graph using the graphical symbol representing the selected entities and the graphical symbol representing the selected topology.

16. The apparatus according to claim 14 wherein the apparatus is further caused to perform the following:
monitor the status of said selected entities; and
if a change in the status of at least one entity is detected, send a message from said at least one entity to inform the change in the status using the dataflow graph to determine a receiver of said message.

17. The apparatus according to claim 14 wherein the apparatus is further caused to perform the following:
select a first entity and a second entity among the selected entities; and
connect the first entity with the second entity for delivering messages between the first entity and the second entity.

18. The apparatus according to claim 17, said message interface comprising an input port and an output port, wherein the apparatus is further caused to perform the following:
connect the output port of the first entity to the input port of the second entity for delivering messages from the first entity to the second entity.

19. The apparatus according to claim 14, wherein said apparatus is further caused to perform the following:
select a topology; and
select another topology for the dataflow graph; and
said apparatus is further caused to perform the following:
define a dataflow graph is and reconfigure the dataflow graph by using the selected another topology and the selected entities.
